(19) United States
(12) Patent Application Publication
(10) Pub. No.: US 2006/0104294 A1
(43) Pub. Date: May 18, 2006

(54) Router and method of managing packet queue using the same

(76) Inventor: Tae-Joon Yoo, Seoul (KR)

Correspondence Address: ROBERT E. BUSHNELL, 1522 K STREET NW, SUITE 300, WASHINGTON, DC, 20005-1202, US

(21) Appl. No.: 11/271,862

(22) Filed: Nov. 14, 2005

(30) Foreign Application Priority Data
Nov. 16, 2004 (KR) 2004-93741

(51) Int. Cl. H04L 12/56

(52) U.S. Cl. 370/401; 370/412

(57) ABSTRACT

A router for performing queue management for packet transmission is provided, which includes a first storage unit for storing and outputting packets input to request transmission from a source device to a destination device; a second storage unit for storing information on the packets stored in the first storage unit; and a packet-processing determination unit for determining whether the input packets are to be stored in the first storage unit, based on whether there is a available storage capacity in the first storage unit, and updating information on the packets into the second storage unit.

### CLAIM OF PRIORITY

This application makes reference to, incorporates the same herein, and claims all benefits accruing under 35 U.S.C. 19 from an application entitled ROUTER AND METHOD OF MANAGING PACKET QUEUE USING THE SAME earlier filed in the Korean Intellectual Property Office on Nov. 16, 2004 and thereby duly assigned Serial No. 2004-93741.

### BACKGROUND OF THE INVENTION

1. Technical Field

The present invention relates to a router and method of managing a packet queue using the same and, more particularly, to a router and method of managing a packet queue using the same capable of controlling packet transmission while maintaining fair buffer occupation.

2. Related Art

In general, different traffics of several sizes and transmission rates are flowing over the Internet. Queue managing and scheduling schemes are used to minimize problems, such as congestion, that may occur while the traffics flow over the Internet.

One such problem is unfairness for traffics. The term ‘unfairness’ refers to a phenomenon that a small number of specific traffics occupy a large portion of a buffer capacity of a router without considering fairness.

FIG. 1 is a diagram illustrating an example of an unfairness phenomenon of traffics on the Internet.

As shown in FIG. 1, there is a network having a link bandwidth of 10 Mbps between a router 30 and a router 40.

In FIG. 1, when application A 10 and application B 20, that use a transmission control protocol (TCP) and a user datagram protocol (UDP), respectively, are in a race condition for a buffer of router 30, the application B 20 using the UDP occupies most of the buffer capacity of router 30 in the end.

That is, when the application B 20 using the UDP transmits a packet of more than 10 Mbps to a sink for B 60, it will occupy most of the link bandwidth as time passes. Therefore, even though the application A 10 using the TCP desires to transmit the packet to a sink for A 50, there is no remaining bandwidth for transmission, which results in unfairness of transmission.

Queue managing and scheduling schemes have been proposed to solve the foregoing problem.

One such example is drop tail queue management based FIFO (First In First Out), or First Come First Serve (FCFS), scheduling. This has an advantage in that simple packet forwarding minimizes an overhead of packet processing and is easily implemented. However, the drop tail based FIFO scheduling supports only a best effort service. In other words, this scheme has structural disadvantages in that no quality of service is guaranteed and that a buffer of the router can be occupied by some flows that generate a number of traffics.

Various queue management algorithms and packet scheduling mechanisms have been proposed to improve disadvantages of the drop tail based FIFO scheduling. Among these, an IntServ (Integrated Services) model adds a new service class as well as best effort services. In order to add these services, the router should secure necessary resources to guarantee required quality of service for the flow. The secured resources include a bandwidth, a memory, and so on. A protocol such as RSVP (Resource Reservation Protocol) is used to secure the resources.

However, there are problems with the IntServ model in that it has insufficient extensibility and requires a number of resources because it secures resources for the services in advance and retains information for all the flows.

A DiffServ (Differentiated Services) model was introduced to solve the problems with the IntServ model. In the DiffServ model, various flows are classified into several service classes, and processing in an intermediate router is made for each service class. The DiffServ model does not require flow state managing and signaling for all routers. The DiffServ model specifies a required service class in a specific bit of a header of the packet. This scheme classifies all traffics depending on required QoS (Quality or Service) and accordingly aggregates relevant traffics to solve the scheduling issue.

In addition, RED (LRU-RED) (least recently used—random early detection) and FQ (LRU-FQ) (least recently used—fair queing) using a partial state scheme have been proposed as a model at a midway between the IntServ model and the DiffServ model. The term ‘partial state’ indicates that, unlike the IntServ model, a router does not retain information for all flows but retains only information for specific flows using a limited memory. Memory management for information of these flows follows an LRU algorithm.

A flow in which packets are frequently sent over relatively long time has higher probability that the information in the flow is stored in a memory by virtue of characteristics of the LRU algorithm. Here, the flow with the information stored in the memory is defined as a flow that transmits relatively more packets than that with no information stored in the memory, i.e., a flow violating fairness.

Input packets are analyzed by the router. The packets are subject to prescribed regulations when the packets correspond to the flow contained in the memory. Here, in the case of the LRU-RED, the RED algorithm having a high possibility of drop for the flows stored in the memory is applied. The LRU-FQ uses two memories. Packets are stored in a queue for a flow stored in the memory and a queue for a flow not stored in the memory and then are applied with equivalent scheduling to suppress the unfairness.

However, the IntServ model requires each router to store state information for the flow. In turn, this requires a great capacity of storage in the router and greatly affects a processing speed in much flow. Further, high overhead is accompanied by processing control-related functions such as access management and approval/permission. Finally, all of the routers at the midway should support the IntServ model, thus degrading the extensibility.

Meanwhile, a traffic aggregation model used in the DiffServ model has poor prediction. Therefore, it is very difficult for the DiffServ model to guarantee a specific level of service. Accordingly, the DiffServ model provides a relative service based on rules of each aggregation rather than guarantees a specific level of service. In other words, some aggregations receive data better than or worse than other aggregations.

The LRU-RED holds shortcomings of the RED queue management as they are. It degrades overall buffer usage. In addition, it is difficult to establish a reliable regulation policy since the regulation is based on probability.

The LRU-FQ causes a problem of packet recording, and a fairness problem in a network where there are a number of flows that exchange small number of packets.

### SUMMARY OF THE INVENTION

The present invention has been made to solve the aforementioned problems. It is an object of the present invention to provide a router and method of managing a queue using the same, capable of maintaining fairness for a buffer without causing a specific flow to occupy all buffers of a router, by using a partial state.

It is another object of the present invention to provide a router and method of managing a packet queue using the same, capable of relieving a requirement on a use storage space by using a partial state scheme.

According to an aspect of the present invention, there is provided a router performing queue management for packet transmission, including: a first storage unit for storing and outputting packets input to request transmission from a source device to a destination device; a second storage unit for storing information on the packets stored in the first storage unit; and a packet-processing determination unit for determining whether the input packets are to be stored in the first storage unit, based on whether there is a available storage capacity in the first storage unit, and updating information on the packets into the second storage unit.

Preferably, the second storage unit may contain a flow ID (F) that is information on the source device that requests the packet transmission; a hit count (H) indicative of the number of times at which the same source device requests the transmission; and a p_pos_queue (P) indicative of information on where the packet stored in the first storage unit is positioned.

When there is no storage space in the first storage unit and a summation of the hit counts is smaller than a set threshold, the packet-processing determination unit may drop the input packet and update the flow ID for the dropped packet according to a least recently used (LRU) algorithm.

When there is a storage space to store the packet in the first storage unit, the packet-processing determination unit may store the input packet into the first storage unit and update information containing the flow ID for said packet according to an LRU algorithm.

When there is no storage space in the first storage unit and a summation of the hit counts is larger than a set threshold, the packet-processing determination unit may detect, from the first storage unit, a packet of the flow ID having the largest hit count from the second storage unit, store the input packet into an empty space of the first storage unit, and update information on the stored packet into the second storage unit.

When the flow ID of the input packet is stored in the second storage unit and the hit count is the maximum value, the packet-processing determination unit may update the flow ID according to an LRU algorithm.

When the flow ID of the input packet is stored in the second storage unit and the hit count is not the maximum value, the packet-processing determination unit may decrement the maximum value of the hit count stored in the second storage unit by ‘1’ and increment the hit count for the input packet by ‘1’ while updating the flow ID according to the LRU algorithm.

When the flow ID of the input packet is not stored in the second storage unit and there is a space to update, the packet-processing determination unit may store an entry corresponding to the input packet into the second storage unit.

When the flow ID of the input packet is not stored in the second storage unit and the update for update does not exist, the packet-processing determination unit may delete an entry that is least recently used according to the LRU algorithm and update the corresponding entry for the input packet at the deleted space.

According to another aspect of the present invention, there is provided a method of managing a queue for packet transmission using a router, the method comprising the steps of: receiving packets that request transmission from a source device; determining whether there is an available storage space in a first storage unit for storing the packets; when a storage space is not exist in the first storage unit, determining whether the packets are to be stored and dropped according to a comparison result between the number of transmission repetition of the packet for the source device and a set threshold; and updating information on the packets processed according to the determination result into a second storage unit that stores information on the packets.

When there is no storage space in the first storage unit and a summation of the hit counts is smaller than the set threshold, updating information includes: dropping the input packet; and updating the flow ID for the dropped packet according to a least recently used algorithm (LRU).

When there is a storage space to store the packet in the first storage unit, updating information includes: storing the input packet into the first storage unit; and updating information containing the flow ID for said packet according to an LRU algorithm.

When there is no storage space in the first storage unit and a summation of the hit counts is larger than a set threshold, updating information includes: detecting, from the first storage unit, a packet of the flow ID having the largest hit count from the second storage unit; storing the input packet into an empty space of the first storage unit; and updating information on the stored packet into the second storage unit.

According to the present invention, a requirement on a storage space can be relieved using a partial state scheme and, based on it, unfairness for buffer occupation is controlled up to a level defined through a threshold so that buffer occupation for packets can be more fairly controlled. Further, when there is no storage space in the buffer, queue management for the relevant packet is performed, thereby maximizing buffer utilization. Furthermore, if necessary, it is easy to change a buffer management policy by adjusting a regulation on buffer based on the threshold.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a diagram illustrating an unfairness phenomenon of traffics on the Internet;

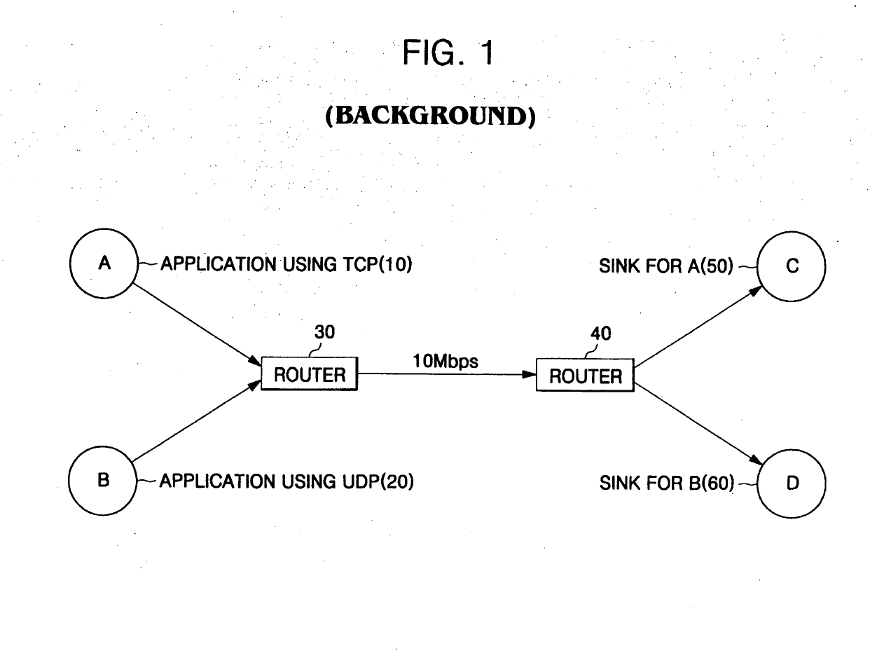

FIG. 2 is a diagram showing a structure of a cache having information on flows input from a corresponding source device according to an embodiment of the present invention;

FIG. 3 is a diagram showing a router for least recently used-longest queue drop (LRU-LQD) queue management according to an embodiment of the present invention;

FIG. 4 is a flow chart showing an exemplary queue management method using a router according to the present invention;

FIG. 5 is a flow chart showing processing a packet input following a process of detecting a flow ID having the largest hit count from the cache;

FIG. 6 is a flow chart specifically showing a process of updating packet related information as well as the flow ID of a packet stored in a buffer into the cache; and

FIG. 7 is a diagram showing an example of a pseudo code for an LRU-LQD queue management method using a router according to an embodiment of the present invention.

### DETAILED DESCRIPTION OF THE PREFERED EMBODIMENTS

Hereinafter, the configuration and operation of embodiments of the present invention will be described in more detail with reference to the accompanying drawings. In the drawings, like numbers refer to like elements. In addition, when detailed description on known related functionality or configuration would make the gist of the present invention ambiguous, it will be omitted.

According to the present invention, a least recently used-longest queue drop (LRU-LQD) queue management method capable of maintaining fairness with respect to buffer utilization in a router for traffic using a partial state that uses only certain limited information rather than information on all flows is proposed and disclosed.

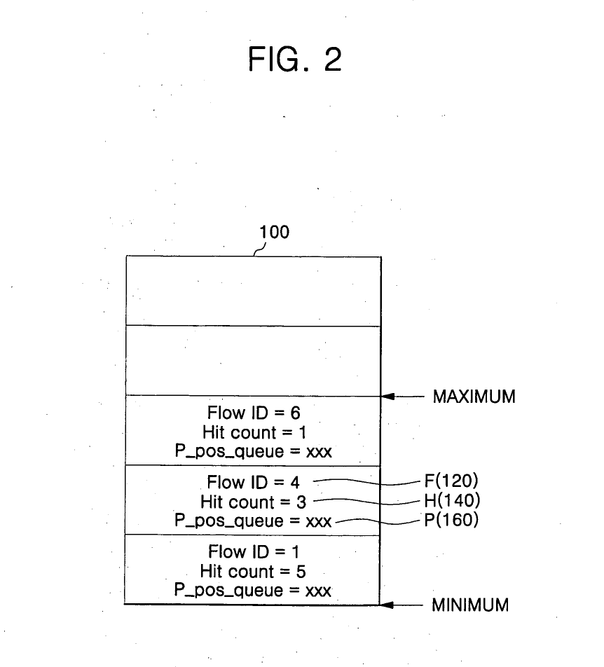

FIG. 2 is a diagram showing a structure of a cache having information on flows input from a corresponding source device according to an embodiment of the present invention.

As shown in FIG. 2, a cache 100 includes a flow ID (F) 120 that is information on a source device requesting to send a relevant packet; a hit count (H) 140 indicative of the number of times at which the same source device requests to send the packet; and a p_pos_queue (P) 160 indicative of information on where the relevant packet in the queue is positioned. Here, the term ‘hit’ means that, when the packet is input to the router, the source device that has transmitted the input packet is matched to the flow ID (F) 120 set in the cache 100. In other words, the hit count (H) 140 refers to the number of times at which the packet requested for transmission from the same source device is input.

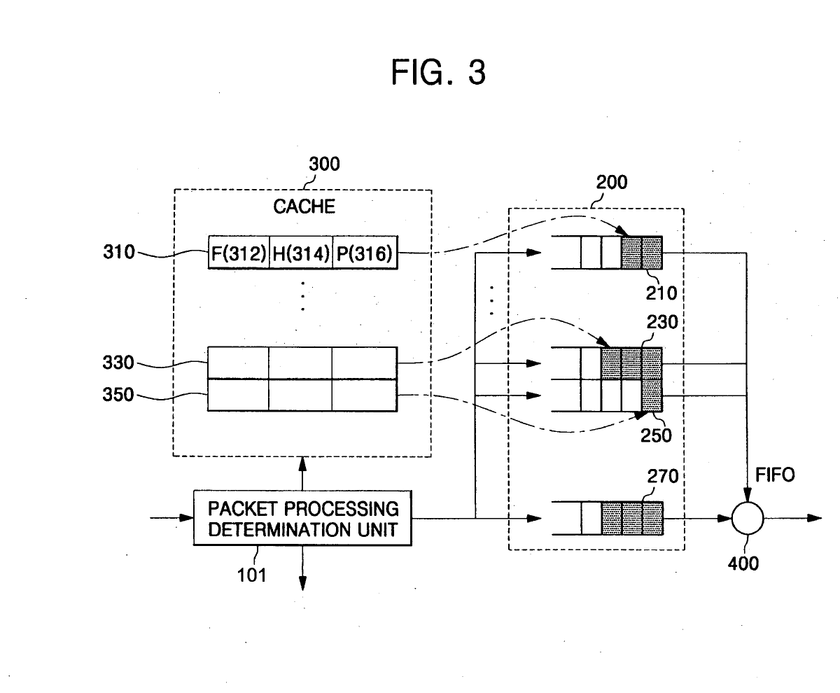

FIG. 3 is a diagram showing a router for least recently used—longest queue drop (LRU-LQD) queue management according to a preferred embodiment of the present invention.

As shown in FIG. 3, the router includes a packet-processing determination unit 101, a queue 200, a cache 300, and a first-in first-out (FIFO) unit 400.

The packet-processing determination unit 101 determines whether input packets are to be stored or dropped, based on whether a buffer of the queue 200 is available.

The queue 200 stores and outputs the packets received from the packet-processing determination unit 101 in the buffer thereof. Here, after storing the input packets in the buffer, the queue 200 sequentially outputs the stored packets to the FIFO unit 400 depending on whether packet output is possible.

The cache 300 also stores information 310,330 and 350 on the packets stored in the queue under the control of the packet-processing determination unit 101. The cache 300 respectively stores the information 310, 330 and 350, corresponding to each of the packets stored in corresponding buffers 210,230, and 250 provided in the queue, on a packet basis. For example, under the control of the packet-processing determination unit 101, the cache 300 stores the information 310 including flow ID (F) 312, hit count (H) 314, and packet store position (P) 316, for the packets stored in the first buffer 210 of the queue 200.

Queue 200 is logically provided with a single buffer unit comprised of a plurality of buffers. FIG. 3 illustrates some of these buffers as buffers 210, 230 and 250 that respectively correspond to the information 310, 330 and 350 of cache 300 and to respective source devices requesting the packet transmission. Queue 200 also includes, as part of its buffer unit, a buffer 270 to be discussed below. As indicated above, the buffers are regarded as a single buffer unit.

The FIFO unit 400 outputs the packets received from the respective buffers 210,230,250, and 270 of the queue 200 in a first-in first-out manner. The output packets are transmitted to destination devices over a transmission line, respectively.

Meanwhile, when determining whether the input packets are to be dropped or stored, the packet-processing determination unit 101 makes a determination based on whether there is an available storage space in the queue 200 and based on a result of comparing the summation of hit count information H for respective packets stored in the cache 300 to a set threshold.

In other words, upon receipt of the packets, if there is no available storage space in the buffer unit provided in queue 200 of the router and the summation of the hit counts H of the cache is less than the threshold, the packet-processing determination unit 101 drops the input packets and updates the flow ID (F) for the dropped packets to the cache 300 according to the least recently used (LRU) algorithm. This case means that unfairness with respect to buffer occupation for the packets does not exceed a user-defined range.

When there is no available storage space in the buffer unit provided in queue 200 of the router, and the summation of the hit counts (H) of the cache is larger than the set threshold, the packet-processing determination unit 101 detects the packet having the flow ID (F) corresponding to the largest hit count (H) among the packets in queue 200. The detected packet is dropped, and the currently input packet is stored in the buffer unit of queue 200. When the hit count (H) in the cache 300 corresponding to the currently input packet is the largest one, the packet-processing determination unit 101 does not perform the above procedure, and instead, drops the flow.

The corresponding changes in the cache 300 include the following three cases:

The first case is that the flow ID (F) of the input packet is already stored in cache 300 and its hit count (H) is the largest. In this case, only a process is performed in which the information, e.g., information 310, on the packets in the cache 300 is updated according to the LRU algorithm.

The second case is that the flow ID of the input packet is already in cache 300 but its hit count (H) is not the largest. In this case, the largest hit count (H) of another packet stored in cache 300 is decremented by ‘1’, while the hit count (H) corresponding to the flow ID (F) of the input packet is incremented by ‘1’. Next, the cache 300 is updated according to the LRU algorithm.

The third case is that the flow ID (F) of the input packet is not in the cache 300. At this time, the packet-processing determination unit 101 determines whether there is an available storage space in the cache 300 to store the input packet and its information.

When there is an available storage space, the packet-processing determination unit 101 stores a corresponding entry in the cache 300. When there is no storage space in the cache 300, the packet-processing determination unit 101 deletes the least recently used entry according to the LRU algorithm and then stores information on the currently input packet.

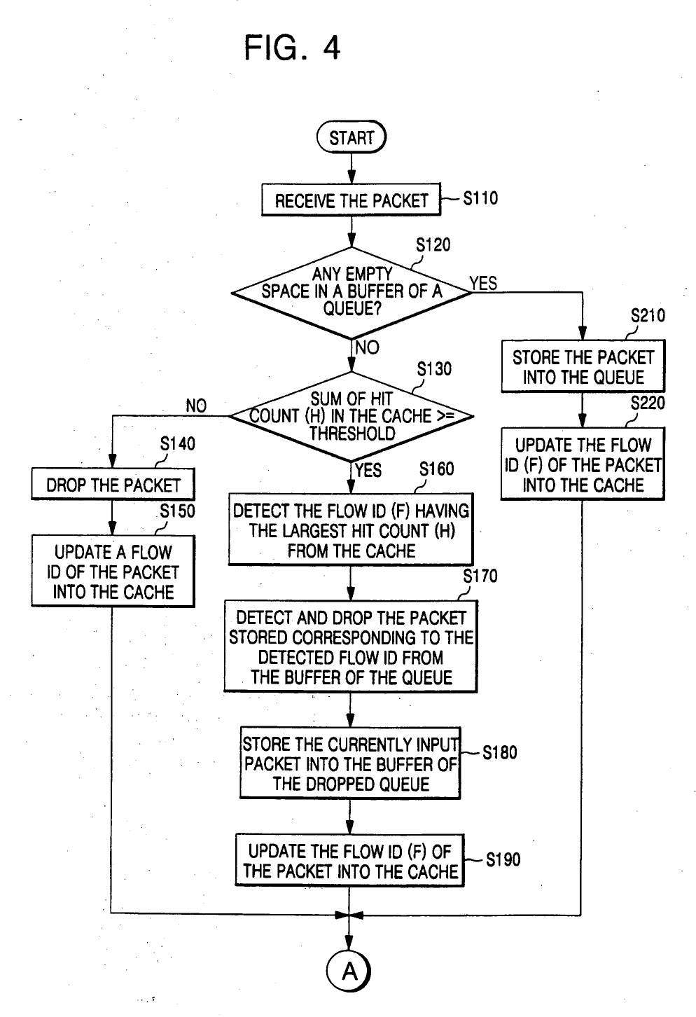

FIG. 4 is a flow chart showing an exemplary method of managing a queue using a router according to the present invention.

First, when the packet-processing determination unit 101 receives a packet from the source device (S110), it determines whether there is an empty space in the buffer unit provided in queue 200 to store the packet (S120). If it is determined that there is space to store the received packet, the packet-processing determination unit 101 stores the packet into buffer 270 of queue 200 (S210). The packet-processing determination unit 101 updates packet related information, as well as the flow ID of this packet stored in the buffer 270, into the cache 300 (S220).

Meanwhile, when it is determined in step S120 that there is no buffer space to store the packet in the queue 200, the packet-processing determination unit 101 determines whether the summation of the hit counts (H) of the cache 300 is larger than the threshold (S130). When it is determined that the summation of the hit counts is smaller than the threshold, the packet-processing determination unit 101 drops the input packet (S140), and updates related information as well as the flow ID of the packet into the cache 300 (S150).

On the other hand, when it is determined in step S130 that the summation of the hit counts is larger than the threshold, the packet-processing determination unit 101 detects the flow ID (F) of the packet having the largest hit count in the cache 300 (S160).

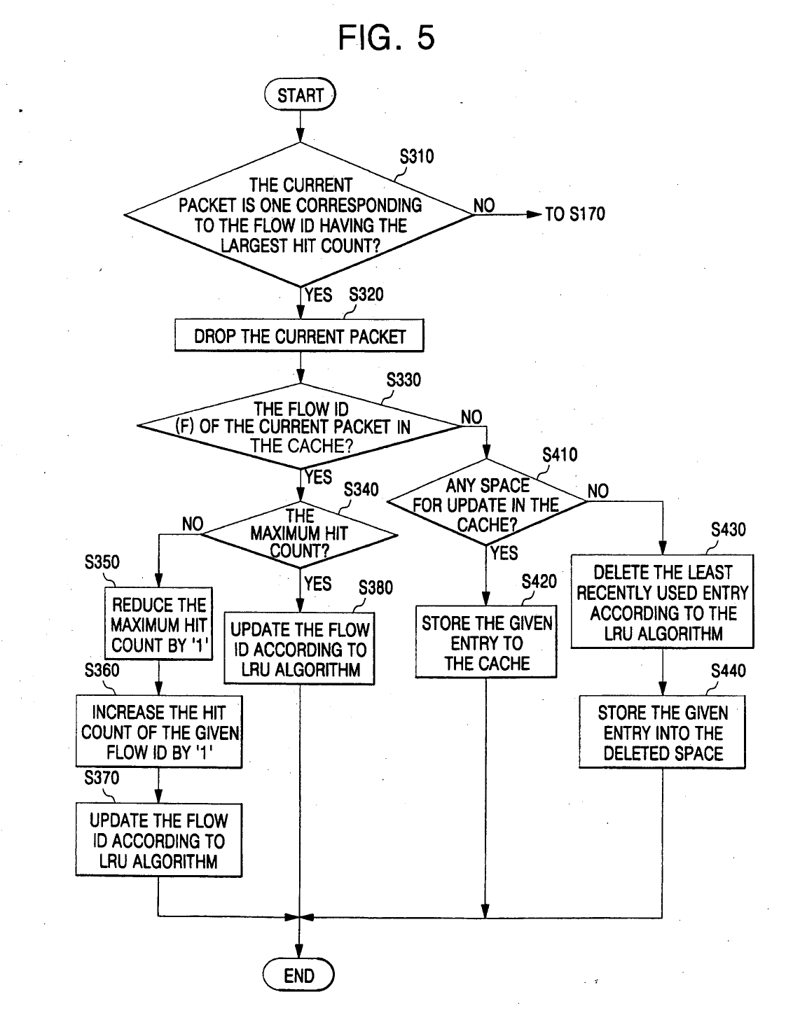

The packet-processing determination unit 101 then detects and drops the stored packet, corresponding to the detected flow ID (F), from the buffer unit of queue 200 (S170), unless the currently received packet corresponds to an already stored packet having the largest hit count (H) (in this case see the procedure of FIG. 5).

At this time, the packet-processing determination unit 101 stores the currently received packet into the vacated buffer of the dropped queue 200 (S180). In addition, the packet-processing determination unit 101 updates information including the flow ID (F) of the packet into the cache 300 (S190).

FIG. 5 is a flow chart showing a procedure of processing an input packet that is a subprocess of step S160 of FIG. 4.

First, the packet-processing determination unit 101 determines whether the currently received packet corresponds to a packet of the flow ID (F) having the largest hit count (S310). When it is determined that the currently input packet does not correspond to the flow ID (F) having the largest hit count (H), the process proceeds to step S170 of FIG. 4.

When the currently input packet corresponds to packet of the flow ID (F) having the largest hit count (H), the packet-processing determination unit 101 drops the currently input packet (S320). Then packet-processing determination unit 101 determines whether there is a flow ID (F) corresponding to the currently dropped packet in the cache (S330).

When it is determined that the flow ID (F) of the currently dropped packet is in the cache, the packet-processing determination unit 101 determines whether the hit count (H) is the largest among the hit counts stored in the cache 300 (S340). When it is determined that the hit count (H) of the relevant flow ID (F) corresponding to the currently dropped packet is not the largest, the packet-processing determination unit 101 decrements the maximum hit count value by ‘1’ (S350). That is, the hit count (H) of another packet is determined to having the maximum hit count and this count value is reduced by ‘1’.

Further, the packet-processing determination unit 101 increments the hit count (H) of the relevant flow ID (F) corresponding to the currently dropped packet by ‘1’ (S360). At this time, the packet-processing determination unit updates the flow ID (F) according to the LRU algorithm (S370).

In S340, when it is determined that the hit count (H) of the relevant flow ID corresponding to the currently dropped packet is the maximum, the packet-processing determination unit 101 updates packet related information including the flow ID (F) into the cache 300 according to the LRU algorithm (S380).

On the other hand, when it is determined in step S330 that the flow ID of the currently dropped packet is not in the cache, the packet-processing determination unit 101 determines whether there is a space to update information on the currently input packet into the cache 300 (S410). When it is determined that there is a space to update the packet information, the packet-processing determination unit 101 stores the entry corresponding to the packet in the cache 300 (S420).

In S410, when it is determined that there is no space to update the packet information in the cache 300, the packet-processing determination unit 101 deletes the least recently used entry from the cache 300 according to the LRU algorithm (S430). At this time, the packet-processing determination unit 101 stores the entry corresponding to the packet into the deleted space (S440).

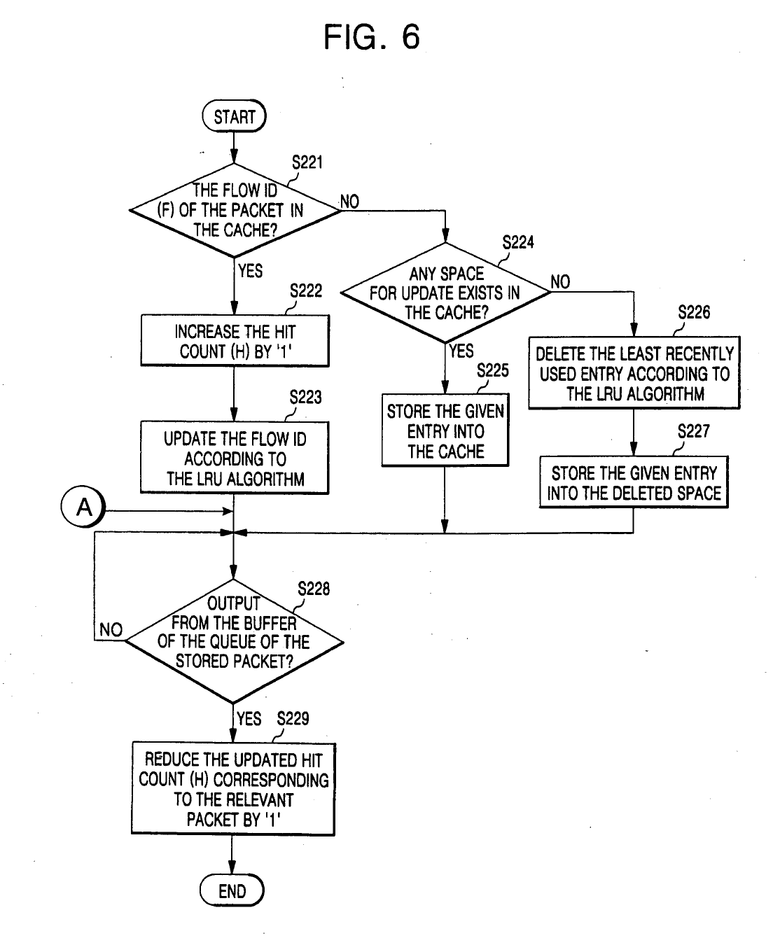

FIG. 6 is a flow chart specifically showing step S220 of FIG. 4.

First, the packet-processing determination unit 101 determines whether the flow ID (F) of the input packet is already in cache 300 (S221). If it is determined that the flow ID (F) is in cache 300, the packet-processing determination unit 101 increments the corresponding hit count (H) stored in cache 300 by ‘1’ (S222). At this time, the packet-processing determination unit 101 updates the flow ID (F) of the packet into the cache 300 according to the LRU algorithm (S223).

Meanwhile, when it is determined in S221 that the flow ID (F) of the input packet is not in cache 300, the packet-processing determination unit 101 determines whether there is a space in the cache 300 to update, or store, information on the input packet (S224). When it is determined that there is space to update information on the packet in cache 300, the packet-processing determination unit 101 stores the entry corresponding to the input packet into the cache 300 (S225).

When it is determined in S224 that there is no space to update information on the packet in cache 300, the packet-processing determination unit 101 deletes the least recently used entry from cache 300 according to the LRU algorithm. At this time, the packet-processing determination unit 101 stores the entry corresponding to the input packet to the now empty space of cache 300 (S227).

Following steps S150 or S190 of FIG. 4, or steps S223, S225 or S227 of FIG. 6, the packet-processing determination unit 101 determines whether one of the packets stored in the buffer unit of queue 200 is output for transmission (S228). If a packet is output from queue 200, the packet-processing determination unit 101 reduces, by ‘1’, the hit count (H) of the corresponding packet stored in cache 300 (S229).

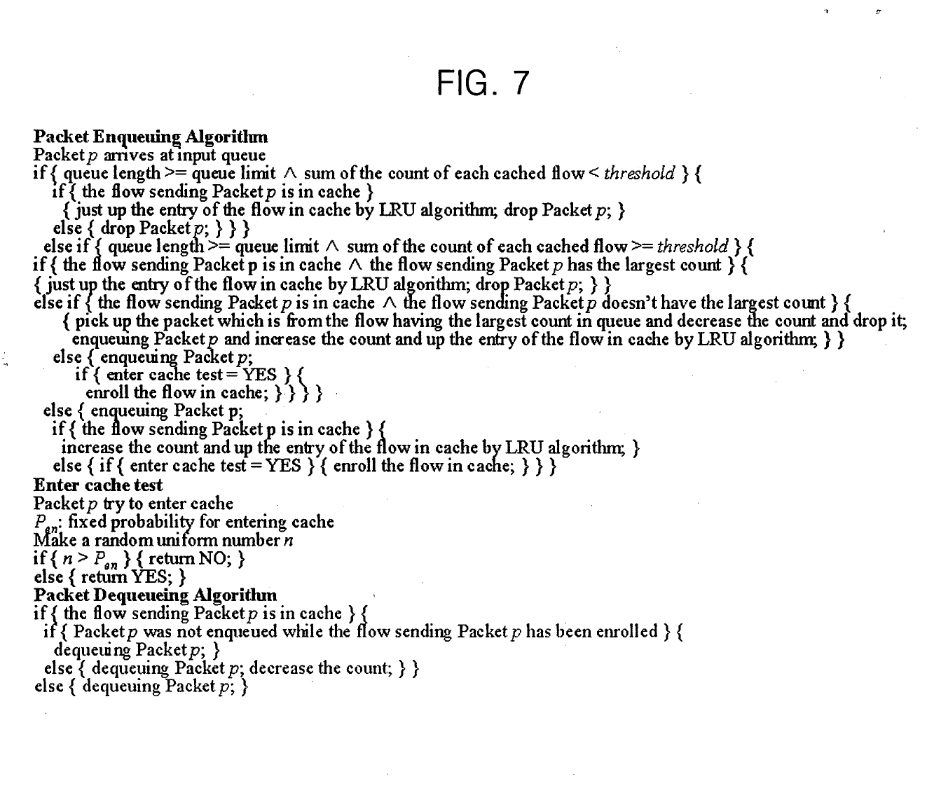

FIG. 7 is a diagram showing an example of a pseudo code for an LRU-LQD queue management method using a router according to an embodiment of the present invention.

Here, the “threshold” and the “entry probability” are factors set by a manager. The higher threshold indicates that the regulation on the flow stored in the cache 300 is relieved. The higher entry probability indicates that the conditions on the flow that may be stored in the cache 300 are relieved. The shown shadow codes include a process of storing or updating information in the cache 300 and a process of managing the queue.

According to the present invention, the requirements for the storage space are relieved using the partial state scheme and, based on it, unfairness for the buffer occupation can be controlled up to a level defined through the threshold. Therefore, the buffer occupation for the packet can be more fairly controlled.

In addition, when there is no storage space in the buffer unit, the buffer utilization can be maximized by performing the queue management for the relevant packet.

Moreover, by adjusting the regulation on the buffer usage according to the threshold, it is easy to change the buffer management policy on demand.

The exemplary embodiments of the present invention have been described and illustrated. However, the present invention is not limited hereto, but those skilled in the art will appreciate that a variety of modification can be made without departing from the spirit of the present invention, which is included in the appended claims.

What is claimed is:

1. A router for performing queue management for packet transmission, comprising:
a first storage unit for storing and outputting packets input to request transmission from a source device to a destination device;
a second storage unit for storing information on the packets stored in the first storage unit; and
a packet-processing determination unit for determining whether the input packets are to be stored in the first storage unit, based on whether there is available storage capacity in the first storage unit, and updating information on the packets into the second storage unit based on the determination result.

2. The router according to claim 1, wherein said information stored the second storage unit comprises:
a flow ID (F) that is information on the source device that requests the packet transmission;
a hit count (H) indicative of the number of times at which the same source device requests the transmission; and
a p_pos_queue (P) indicative of information on where the packet stored in the first storage unit is positioned.

3. The router according to claim 2, wherein, when there is no storage space in the first storage unit and a summation of the hit counts is smaller than a set threshold, the packet-processing determination unit drops the input packet and updates the flow ID (F) for the dropped packet according to a least recently used (LRU) algorithm.

4. The router according to claim 2, wherein, when there is a storage space to store the packet in the first storage unit, the packet-processing determination unit stores the input packet in the first storage unit and updates information containing the flow ID (F) for said packet according to a least recently used (LRU) algorithm.

5. The router according to claim 2, wherein, when there is no storage space in the first storage unit and a summation of the hit counts is larger than a set threshold, the packet-processing determination unit detects, from the first storage unit, a packet of the flow ID (F) having the largest hit count (H) from the second storage unit, stores the input packet into an empty space of the first storage unit, and updates information on the stored packet into the second storage unit.

6. The router according to claim 5, wherein, when the flow ID (F) of the input packet is stored in the second storage unit and the hit count (H) is the maximum value, the packet-processing determination unit updates the flow ID (F) according to a least recently used (LRU) algorithm.

7. The router according to claim 6, wherein, when the flow ID (F) of the input packet is stored in the second storage unit and the hit count (H) is not the maximum value, the packet-processing determination unit decrements the maximum value of the hit count (H) stored in the second storage unit by ‘1’ and increments the hit count (H) for the input packet by ‘1’ while updating the flow ID (F) according to the least recently used (LRU) algorithm.

8. The router according to claim 7, wherein, when the flow ID (F) of the input packet is not stored in the second storage unit and there is a space to update, the packet-processing determination unit stores an entry corresponding to the input packet into the second storage unit.

9. The router according to claim 8, wherein, when the flow ID (F) of the input packet is not stored in the second storage unit and there is no space to update, the packet-processing determination unit deletes an entry that is least recently used according to the least recently used (LRU) algorithm and updates the corresponding entry for the input packet at the deleted space.

10. A method of managing a queue for packet transmission using a router, comprising:
receiving packets requesting transmission from a source device;
determining whether there is an available storage space in a first storage unit for storing the packets;
when the storage space is not in the first storage unit, determining whether the packets are to be stored and dropped, based on a result of comparing the number of times at which the source device requests the transmission to a set threshold; and
updating information on the packets processed according to the determination result into a second storage unit that stores information on the packets.

11. The method according to claim 10, wherein the information on the packets stored in the second storage unit comprises:
a flow ID (F) that is information on the source device that requests the packet transmission;
a hit count (H) indicative of the number of times at which the same source device requests the transmission; and
a p_pos_queue (P) indicative of information on where the packet stored in the first storage unit is positioned.

12. The method according to claim 11, wherein updating the information comprises, when there is no storage space in the first storage unit and a summation of the hit counts is smaller than the set threshold, dropping the input packet and updating the flow ID (F) for the dropped packet according to a least recently used (LRU) algorithm.

13. The method according to claim 11, wherein updating the information comprises, when there is a storage space to store the packet in the first storage unit, storing the input packet into the first storage unit, and updating information containing the flow ID (F) for said packet according to a least recently used (LRU) algorithm.

14. The method according to claim 11, wherein updating the information comprises: when there is no storage space in the first storage unit and a summation of the hit counts is larger than a set threshold, detecting, from the first storage unit, a packet of the flow ID (F) having the largest hit count (H) from the second storage unit; storing the input packet into an empty space of the first storage unit; and updating information on the stored packet into the second storage unit.

15. The method according to claim 15, wherein updating the information further comprises, when the flow ID (F) of the input packet is stored in the second storage unit and the hit count (H) is the maximum value, updating the flow ID (F) according to a least recently used (LRU) algorithm.

16. The method according to claim 15, wherein updating the information further comprises, when the flow ID (F) of the input packet is stored in the second storage unit and the hit count (H) is not the maximum value, decrementing the maximum value of the hit count (H) stored in the second storage unit by ‘1’ and incrementing the hit count (H) for the input packet while updating the 5 flow ID (F) by ‘1’ according to the least recently used algorithm.

17. The method according to claim 16, wherein updating the information further comprises, when the flow ID (F) of the input packet is not stored in the second storage unit and there is a space to update, storing an entry corresponding to the input packet into the second storage unit.

18. The method according to claim 17, wherein updating the information further comprises, when the flow ID (F) of the input packet is not stored in the second storage unit and there is no space to update, deleting an entry that is least recently used according to the least recently used algorithm, and updating the corresponding entry for the input packet in the deleted space.
